(19) United States
(12) Patent Application Publication
(10) Pub. No.: US 2009/0319468 A1
(43) Pub. Date: Dec. 24, 2009

(54) INFORMATION PROCESSING APPARATUS AND INFORMATION PROCESSING METHOD

(75) Inventor: Junichi Miyata, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/138,107

(22) Filed: Jun. 12, 2008

(30) Foreign Application Priority Data
Jun. 13, 2007 (JP) 2007-156735

(51) Int. Cl. G06F 17/00; G06F 17/30

(52) U.S. Cl. 707/1; 715/246; 707/E17.005

(57) ABSTRACT

An information processing apparatus includes a circumscribed area generation unit configured to generate a circumscribed area circumscribing data, and a display control unit configured to display a page in which the circumscribed area generated by the circumscribed area generation unit is laid out at the position of a designated area.

### BACKGROUND OF THE INVENTION

1. Field of the Invention

The present invention relates to an information processing apparatus used in variable data printing to insert variable data stored in a database into an electronic document file, and edit, display, and print a document page.

2. Description of the Related Art

There has been conventionally known variable data printing capable of inserting customer data such as an address into a template laid out for printing, and replacing the customer data with another one and printing the data as needed. Variable data printing is done by merging variable data such as address data stored in a database and an electronic document file serving as a template. In general, variable data printing is a typical method of the Print-on-Demand technique, and the process of editing digital data to generate a final printed material is roughly divided into a prepress process, press process, and post process. Page layout processing of a printed material belongs to the prepress process.

Generally, page layout processing of a printed material includes various operations such as layout of a photograph and illustration, imposition, and insertion of variable data. A plurality of operators often engage in the work, including one who lays out pages, one who inserts variable data, and one who checks a final printed material. In most cases, variable data stored in a database for use in variable data printing are confidential individual information such as customer information. In the prepress process executed by a plurality of operators in cooperation with each other, it is very important to enhance the security of individual information. To meet this demand, a variety of techniques have been developed.

Japanese Patent Laid-Open No. 2005-346398 discloses a printing system capable of adding authentication information to a form file created by overlying a form template and print data, or each component form of the form file, and saving the authentication information-added form file. Japanese Patent Laid-Open No. 2006-107459 discloses an encryption processing apparatus using a method of generating partial encryption designation data. This apparatus can partially encrypt print data to prevent leakage of information on a communication channel. Japanese Patent Laid-Open No. 2000-306026 discloses an electronic form processing method of defining, separately on the server and client sides, signed parameters as access control parameters for controlling readout and update of input data of a form and records of a business database.

In most conventional configurations, variable data and the like are stored in a network-connected server which ensures security, and only an operator authenticated by a password or the like can access the server from a client PC. However, an unauthenticated user cannot check an electronic document file containing variable data, and cannot edit the style of an entire document.

When a printed material containing variable data is moved to another network segment, even an authenticated user cannot refer to a database in the original network segment. As described above, a plurality of operators are generally involved in the variable data printing process. Demand is growing to increase the workflow efficiency of variable data printing while maintaining the security of variable data.

### SUMMARY OF THE INVENTION

The present invention provides an information processing apparatus capable of increasing the work efficiency of variable data printing by allowing an operator having no authorization to browse to edit the document style while maintaining the security of variable data used in variable data printing.

The present invention in its first aspect provides an information processing apparatus which outputs a preview image when inserting data stored in a database into an area designated by a template on a page that forms document data, and outputting the data, the apparatus comprising:

a circumscribed area generation unit configured to generate a circumscribed area circumscribing the data; and

a display control unit configured to, when a user having no authorization to browse the data designates display of the document data, display a page in which the circumscribed area generated by the circumscribed area generation unit is laid out at a position of the designated area.

The present invention in its second aspect provides an information processing method of outputting a preview image when inserting data stored in a database into an area designated by a template on a page that forms document data, and outputting the data, the method comprising:

a circumscribed area generation step of generating a circumscribed area circumscribing the data; and

a display control step of, when a user having no authorization to browse the data designates display of the document data, displaying a page in which the circumscribed area generated in the circumscribed area generation step is laid out at a position of the designated area.

The present invention in its third aspect provides a computer-readable medium storing an information processing program of outputting a preview image when inserting data stored in a database into an area designated by a template on a page that forms document data, and outputting the data, the information processing program causing a computer

to generate a circumscribed area circumscribing the data, and

to, when a user having no authorization to browse the data designates display of the document data, display a page in which the generated circumscribed area is laid out at a position of the designated area.

The present invention can increase the work efficiency of variable data printing since an operator having no authorization to browse can edit the document style while maintaining the security of variable data used in variable data printing.

Further features of the present invention will become apparent from the following description of exemplary embodiments with reference to the attached drawings.

### BRIEF DESCRIPTION OF THE DRAWINGS

FIG. 1A is a block diagram showing a functional configuration of a variable data printing apparatus according to an embodiment of the present invention;

FIG. 1B is a block diagram showing another functional configuration of the variable data printing apparatus according to the embodiment of the present invention;

FIG. 2 is a block diagram showing the internal arrangement of the variable data printing apparatus;

FIG. 3 is a view schematically showing the data structure of an electronic document file;

FIGS. 4A-1 and 4A-2 are tables showing an example of book attributes shown in FIG. 3;

FIG. 4B is a table showing an example of chapter attributes shown in FIG. 3;

FIG. 4C is a table showing an example of page attributes shown in FIG. 3;

FIG. 5A is a view showing the data structure of a variable data printing item shown in FIG. 4C;

FIG. 5B is a table showing the data structure of the variable data printing item shown in FIG. 4C;

FIG. 5C is a table showing the data structure of the variable data printing item shown in FIG. 4C;

FIG. 5D is a view showing the data structure of the variable data printing item shown in FIG. 4C;

FIG. 5E is a view showing the data structure of the variable data printing item shown in FIG. 4C;

FIG. 5F is a view showing the data structure of the variable data printing item shown in FIG. 4C;

FIG. 6 is a view showing an example of the user interface window of a printing application;

FIG. 7A is a view showing the concept of page layout when performing variable data printing;

FIG. 7B is a view showing the concept of page layout when performing variable data printing;

FIG. 8 is a view showing an example of the user interface of a variable data printing editor;

FIG. 9 is a view showing an example of a user interface used to access a database;

FIG. 10 is a view showing an example of a dialog displayed when password-based authentication is necessary;

FIG. 11A is a view showing the concept of associating a variable field on a document page with data in an external database;

FIG. 11B is a view showing the concept of associating a variable field on a document page with data in an external database;

FIG. 12 is a view showing an example of the user interface of the variable data printing editor in an “overall edit mode”;

FIG. 13 is a flowchart chart showing a processing sequence in the overall edit mode according to the embodiment of the present invention;

FIG. 14 is a view showing an example of a dialog displayed when loading variable data into an electronic document file;

FIG. 15 is a flowchart showing a processing sequence to encrypt variable data and set an authentication password according to the embodiment of the present invention;

FIG. 16 is a flowchart showing a processing sequence when displaying an electronic document file containing encrypted variable data according to the embodiment of the present invention;

FIG. 17A is a table showing the data structure of external and internal databases;

FIG. 17B is a table showing the data structure of external and internal databases;

FIG. 18 is a table showing the data table of the variable data printing item at the end of the flowchart shown in FIG. 15;

FIG. 19A is a view showing an example of a window displayed at the end of the process of the flowchart shown in FIG. 16;

FIG. 19B is a view showing an example of a window displayed at the end of the process of the flowchart shown in FIG. 16;

FIG. 20 is a view showing an example of a window displayed when the circumscribed rectangular area is calculated for each character of a character string;

FIG. 21A is a view showing an example of a window displayed at the end of the process of the flowchart shown in FIG. 13; and

FIG. 21B is a view showing an example of a window displayed at the end of the process of the flowchart shown in FIG. 13.

### DESCRIPTION OF THE EMBODIMENTS

A preferred embodiment of the present invention will be described in detail below with reference to the accompanying drawings. The same reference numerals denote the same parts, and a description thereof will be omitted.

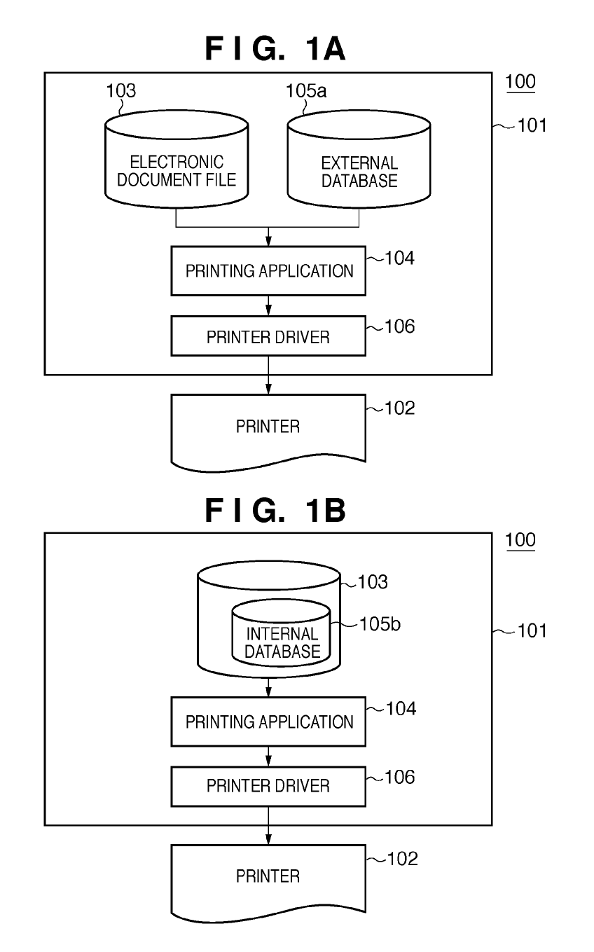

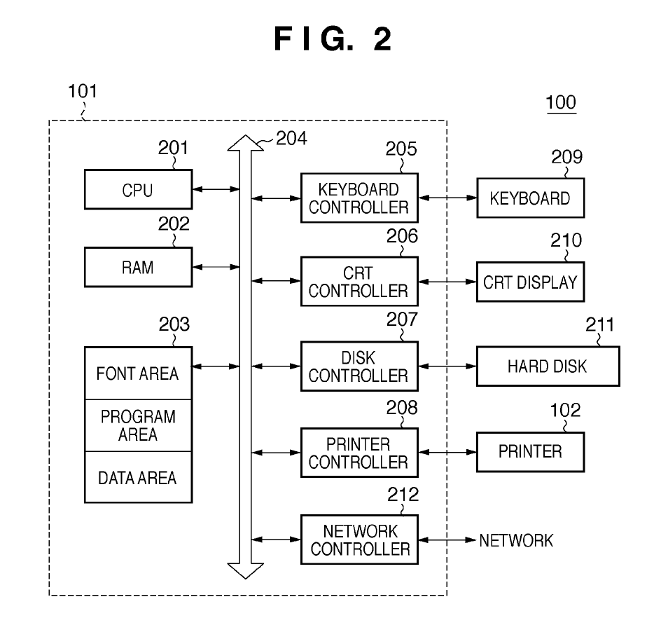

FIG. 1A is a block diagram showing the functional configuration of a variable data printing apparatus according to the embodiment of the present invention. As shown in FIG. 1A, a variable data printing apparatus 100 includes an information processing apparatus 101 and printer 102. The information processing apparatus 101 includes an electronic document file 103 (to be also referred to as document data hereinafter), and a printing application 104 serving as a variable data printing program which edits, updates, and prints the electronic document file 103. The information processing apparatus 101 further includes an external database 105a which stores variable data to be inserted into the electronic document file 103. The information processing apparatus 101 also includes a printer driver 106 which generates a printer description language (PDL) recognized by the printer 102 and transmits it to the printer when the printing application 104 instructs the external printer 102 to print. The electronic document file 103 and external database 105a used by the printing application 104 may also exist in the local drive of the information processing apparatus 101 or in a network drive on a network. The information processing apparatus 101 shown in FIG. 1A is connected to the external printer 102 to constitute the variable data printing apparatus 100. The information processing apparatus 101 provides a variable data printing function of inserting variable data such as an address into an electronic document file and printing.

According to the embodiment, the contents of the external database 105a are loaded into the electronic document file 103. The electronic document file 103 holds, as a template, the layout definition of how to lay out the contents of the external database 105a. FIG. 1B is a block diagram showing a state in which the contents of the external database 105a are loaded into the electronic document file 103. As shown in FIG. 1B, a database loaded into the electronic document file 103 changes into an internal database 105b. Details of loading the contents of the external database 105a into the electronic document file 103 will be described later.

FIG. 2 is a block diagram showing the internal arrangement of the variable data printing apparatus 100. A CPU 201 shown in FIG. 2 executes a program stored in the program area of a ROM 203, or an OS, general-purpose application, or program (e.g., the printing application 104) loaded from a hard disk 211 into a RAM 202. The RAM 202 functions as a main memory, work area, and the like for the CPU 201. A keyboard controller 205 controls a key input from a keyboard 209 or a pointing device (not shown). A CRT controller 206 controls display on a CRT display 210. A disk controller 207 controls access to the hard disk 211 which stores a boot program, various applications, font data, user files, electronic document files, and the like, and other general-purpose disks (examples of a storage unit in the embodiment). A printer controller 208 controls exchange of signals between the variable data printing apparatus 100 and the connected printer 102. A network controller 212 executes communication control processing with other devices connected to a network. The CPU 201 is connected to respective blocks via an internal bus 204.

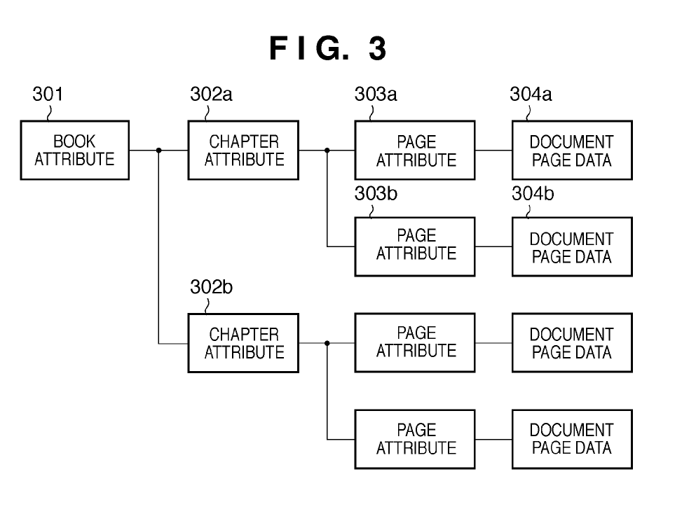

The data structure of the electronic document file 103 will be explained. FIG. 3 is a view schematically showing the data structure of the electronic document file. As shown in FIG. 3, the electronic document file 103 has a three-layered structure which simulates a book of paper media. For example, a data structure which defines the concept of the hierarchy of upper, intermediate, and lower layers is generally known. As shown in FIG. 3, a book attribute 301 is defined as an upper layer, and defines attributes associated with the whole document. Chapter attributes 302a and 302b are defined as intermediate layers, and define attributes for each chapter. Page attributes 303a and 303b are defined as lower layers, and define attributes for each page.

As shown in FIG. 3, one electronic document file 103 includes one book attribute 301, and the book attribute 301 sometimes includes the chapter attributes 302a and 302b. One chapter attribute 302a sometimes includes the page attributes 303a and 303b. The book attribute 301 and chapter attributes 302a and 302b include defined attribute values and links to lower layers as entities. The page attributes 303a and 303b include defined attribute values and data of respective pages (document page data 304a and 304b) as entities.

Hence, as shown in FIG. 3, the book attribute 301 includes defined book attributes, is linked to the two chapter attributes 302a and 302b, and includes chapter attributes. The chapter attribute 302a includes defined chapter attributes, is linked to the two page attributes 303a and 303b, and includes page attributes. The page attributes 303a and 303b include defined attribute values, and also include the document page data 304a and 304b as entities, respectively.

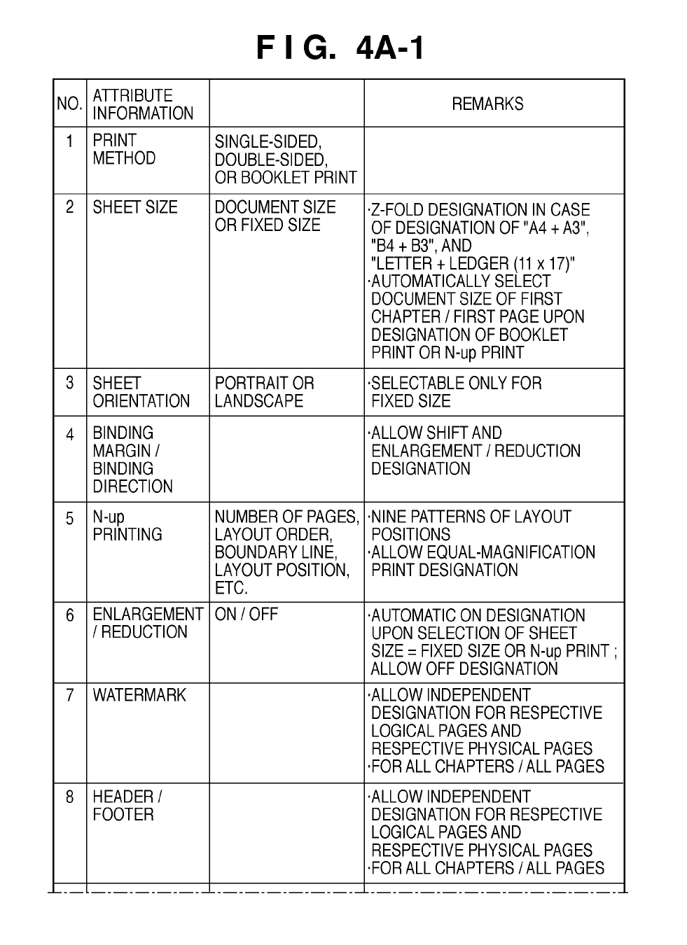

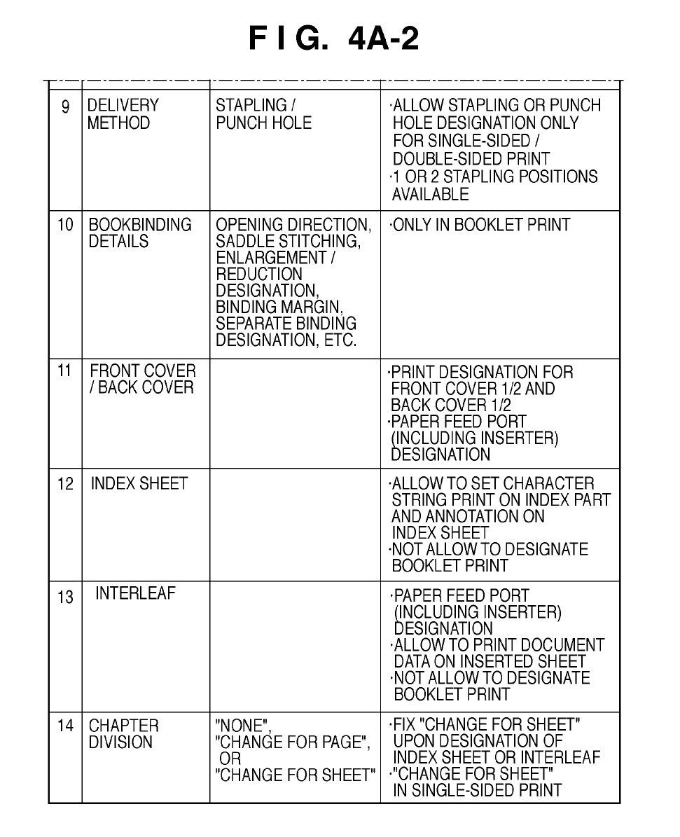

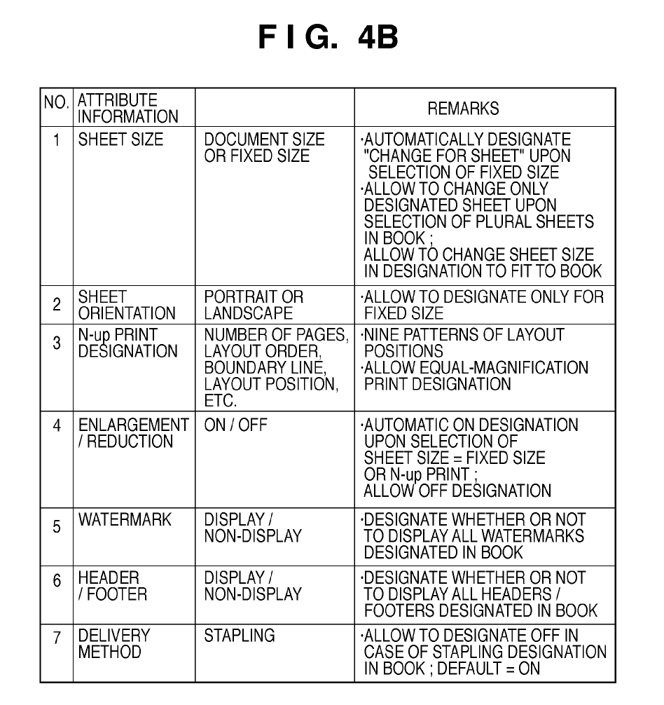

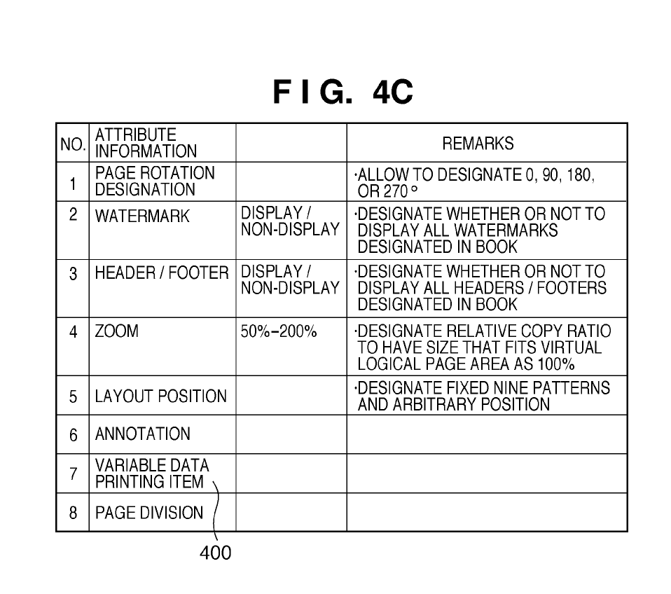

FIG. 4A-1 and 4A-2 are tables showing an example of book attributes shown in FIG. 3. FIG. 4B is a table showing an example of chapter attributes shown in FIG. 3. FIG. 4C is a table showing an example of page attributes shown in FIG. 3. As for items which can be repetitively defined by chapter attributes out of items belonging to book attributes, the attribute values of chapter attributes are preferentially adopted. In this case, items of book attributes that overlap those of chapter attributes are set to specified values used when these items are not defined by chapter attributes. As for items belonging to only book attributes, values defined by book attributes become effective throughout the book. The relationship between chapter attributes and page attributes is the same as that between book attributes and chapter attributes. Items shown in FIGS. 4A to 4C are sometimes defined in association with each other. As shown in FIGS. 4A to 4C, the document size of an electronic document and the like are stored in the attribute items.

As shown in FIG. 4C, a variable data printing item 401 in each page of an electronic document file belongs to the page attributes of the electronic document file 103. The user can set variable data printing for each page via the printing application 104.

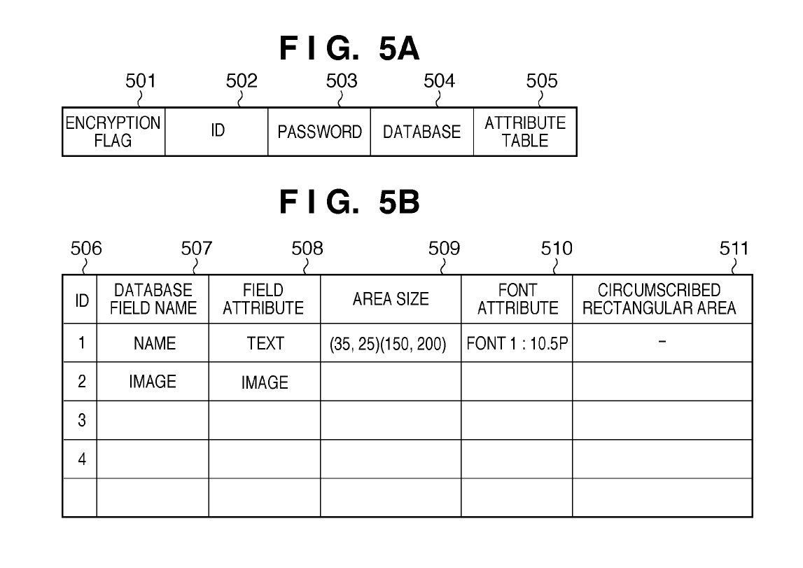

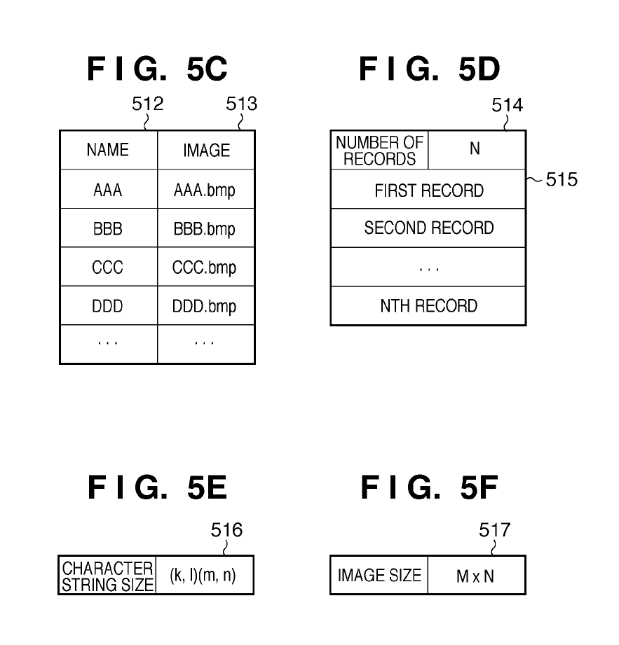

FIG. 5A is a view showing the data structure of the variable data printing item 401 shown in FIG. 4C. As shown in FIG. 5A, the variable data printing item 401 includes a plurality of data areas. In FIG. 5A, an area 501 stores information on encryption of variable data, and an area 502 stores an ID used to authenticate a user who accesses the external database 105a. An area 503 stores a password (to be described later), and an area 504 stores information on the external database 105a serving as a reference destination.

For example, when the variable data printing apparatus 100 is configured as shown in FIG. 1A, the area 504 stores information on the external database 105a. When the variable data printing apparatus 100 is configured as shown in FIG. 1B, the area 504 stores information on the internal database 105b held in the electronic document file 103. An area 505 stores an attribute table regarding a designated area (to be referred to as a variable field hereinafter) which is designated by a template on each page of the electronic document file 103 and receives variable data.

FIG. 5B is a table showing the detailed data structure of the area 505 in FIG. 5A. As shown in FIG. 5B, the area 505 has a table structure made up of a plurality of data areas, but the data may also be defined by another format. An area 506 shown in FIG. 5B stores an ID for identifying a variable field. IDs are stored by the number of variable fields laid out on a page. When the user lays out four variable fields on a page of the electronic document file 103, a combination of lines discriminated by IDs 1 to 4 is stored as shown in FIG. 5B. A plurality of types of data spaces (corresponding to “lines” in FIG. 5B) associated with respective variable fields when laying out the variable fields are called database fields.

An area 507 stores a database field name used to associate each database field with variable data in the external database 105a. For example, in FIG. 5B, the area 507 stores “name” and “image” as database field names. An area 508 stores a field attribute representing the attribute of a database field. For example, in FIG. 5B, the area 508 stores “text” and “image” as field attributes. An area 509 stores the area size of a variable field to which variable data is inserted. The area size represented by the area 509 is the size of a variable field set on a page by the user via the printing application 104.

For example, in FIG. 5B, the variable field is a rectangular area whose diagonal is a line connecting coordinate points (35, 25) and (150, 200). An area 510 stores a font attribute when the field attribute in the area 508 is “text”. For example, in FIG. 5B, the area 510 represents a text in a font “Font 1” with a font size “10.5 point”. The area 510 may also store attributes other than the font and font size. An area 511 stores a circumscribed rectangular area representing the circumscribed area of a rectangle which circumscribes variable data inserted into the electronic document file 103. The area 511 represents the size of a rectangular area which circumscribes variable data inserted into a variable field, unlike the area size of a variable field that can be defined on a page by the user.

FIG. 5C is a table showing the table structure of the area 504 shown in FIG. 5A. FIG. 5C shows variable data of the external database 105a or internal database 105b. The database field names of areas 512 and 513 shown in FIG. 5C correspond to those of the area 507. For example, in FIG. 5C, the areas 512 and 513 store two database field names “name” and “image”.

The table in FIG. 5C represents that four records “AAA”, “BBB”, “CCC”, and “DDD” exist as variable data identified by the database field name “name”. This table also represents that four records “AAA.bmp”, “BBB.bmp”, “CCC.bmp”, and “DDD.bmp” exist as variable data identified by the database field name “image”. That is, this table represents that a plurality of records exist in a database field which defines one variable field.

FIG. 5D is a view showing the detailed data structure of the area 511. An area 514 shown in FIG. 5D stores the number of records. In FIG. 5D, “N” is, for example, “4” or “6”. The area 514 represents that N records exist in the database field. An area 515 stores information on records by the number described in the area 514. For example, when the area 514 holds “3”, the area 515 stores “first record”, “second record”, and “third record”.

FIGS. 5E and 5F are views showing the table structure of each record in the area 515. When the field attribute is “text”, the area 515 stores information of an area 516 shown in FIG. 5E. For example, the area 516 is defined by the coordinates of two points of the diagonal of a rectangular area, like coordinates (k,l) and (m,n). When a character string is inserted into a database field, the area 516 may be the rectangular area of the entire character string or the rectangular area of each character of the character string. When the field attribute is “image”, the area 515 stores information of an area 517 shown in FIG. 5F. For example, the area 517 is defined by the number of pixels in a rectangular area, like “M×N”.

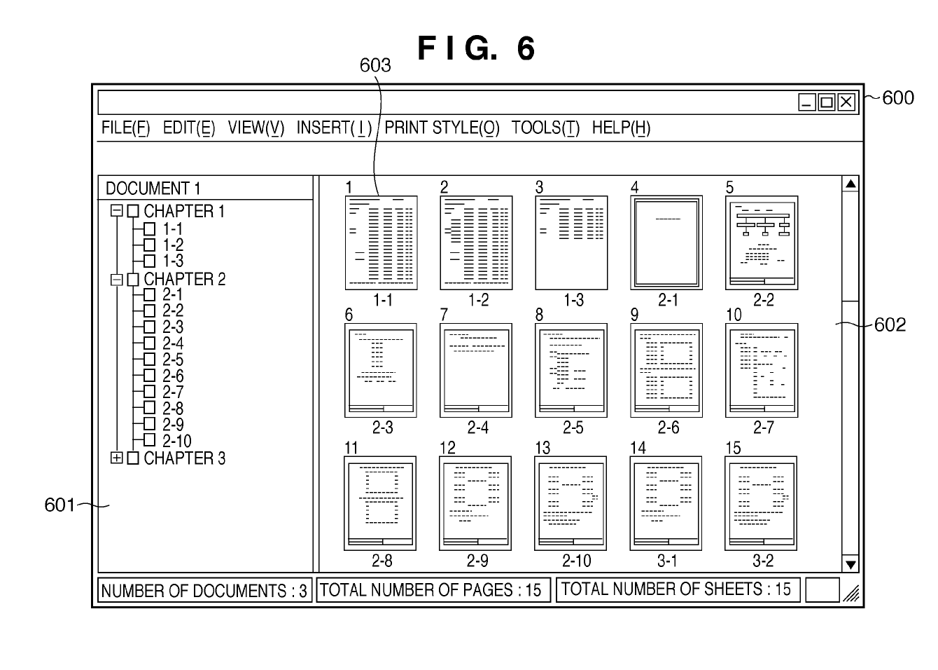

FIG. 6 is a view showing an example of the user interface window of the printing application 104. When the printing application 104 opens the electronic document file 103, a user interface window 600 as shown in FIG. 6 appears. As shown in FIG. 6, the user interface window 600 includes a tree portion 601 representing the tree structure of the electronic document file 103, and a preview portion 602 where a document page 603 is output as a preview image. The document page 603 shown in FIG. 6 corresponds to the document page data 304a or 304b in FIG. 3.

By using the user interface window 600 shown in FIG. 6, the user can process, for example, open, edit, print, and save the entire electronic document file 103. The user can edit the variable data printing item 401 shown in FIG. 4 via the user interface window 600, set a variable field on each page of the electronic document file 103, and set variable data printing.

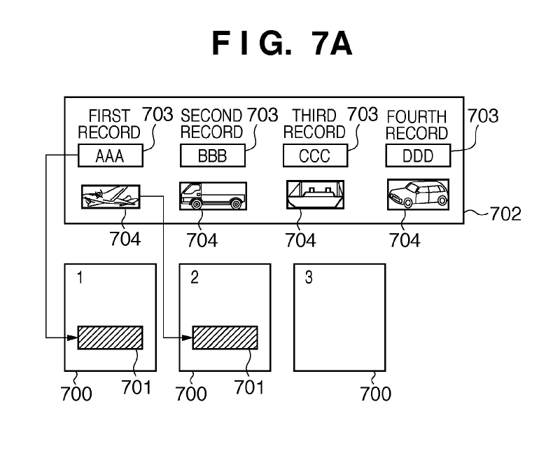

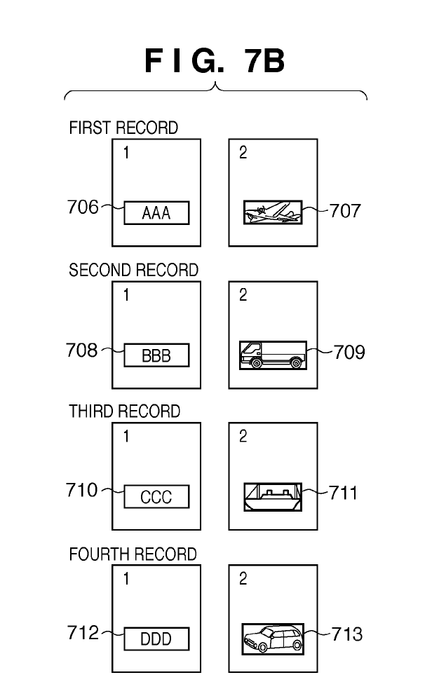

FIGS. 7A and 7B are views showing the concepts of page layout when performing variable data printing. As shown in FIG. 7A, a variable field 701 for executing variable data printing is designated on each document page 700. The variable field 701 is identified by an ID stored in the area 506 shown in FIG. 5B. A figure attached to the upper left corner of each document page 700 is a page number. One variable field 701 is laid out on each document page 700 in FIG. 7A, but it is also possible to lay out a plurality of variable fields 701 or not to lay out the variable field 701.

In the embodiment, data stored in a database 702 is inserted into the variable field 701, the document style is edited, and variable data printing is done. As described with reference to FIGS. 5A to 5F, variable data to be inserted can be changed for a record entered for each variable field 701.

As shown in FIG. 7A, the first to fourth records are entered as variable data in the database 702. The first to fourth records are stored in the database 702 with a table structure as shown in FIG. 5C. Each of the first to fourth records includes variable data 703 whose field attribute is “text”, and variable data 704 whose field attribute is “image”.

As shown in FIG. 7A, the variable data 703 whose field attribute is “text” is inserted into the variable field 701 laid out on the first document page 700. The variable data 704 whose field attribute is “image” is inserted into the variable field 701 laid out on the second document page 700.

FIG. 7B shows the concept of inserting variable data of the database 702 into the document page 700. When the first record is inserted into the document page 700, a text “AAA” represented by variable data 706 is inserted into the first page, and “AAA.bmp” (airplane image) represented by variable data 707 is inserted into the second page. When the second record is inserted into the document page 700, a text “BBB” represented by variable data 708 is inserted into the first page, and “BBB.bmp” (truck image) represented by variable data 709 is inserted into the second page. When the third record is inserted into the document page 700, a text “CCC” represented by variable data 710 is inserted into the first page, and “CCC.bmp” (ship image) represented by variable data 711 is inserted into the second page. When the fourth record is inserted into the document page 700, a text “DDD” represented by variable data 712 is inserted into the first page, and “DDD.bmp” (automobile image) represented by variable data 713 is inserted into the second page. Since no variable field 701 is set on the third document page 700, variable data in the database 702 is not inserted into the third document page 700. When executing variable data printing, the third document page 700 may also be printed for all the first to fourth records. In this case, printing is done by the number of document pages 700×the number of records.

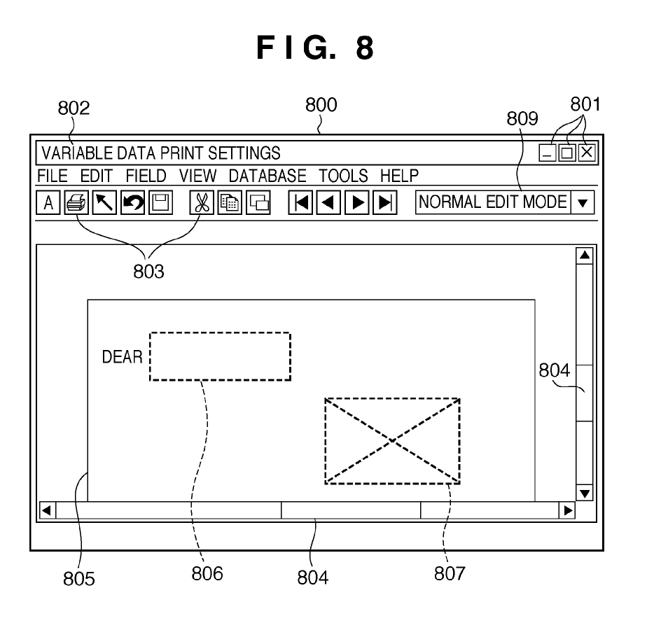

FIG. 8 is a view showing an example of the user interface of a variable data printing editor activated from the printing application. The variable data printing editor allows the user to set variable data printing for each logical page of the electronic document file 103, that is, each document page 603 shown in FIG. 6. A variable data printing editor 800 is activated from the printing application 104. The variable data printing editor 800 may also be activated by, for example, selecting a desired document page 603 at the preview portion 602 of the user interface window 600 and clicking the tool menu or mouse to select a “variable data printing editor”. As shown in FIG. 8, the variable data printing editor 800 includes buttons 801 for minimizing, maximizing, and closing the window, a menu bar 802 for performing various edit operations, and tool buttons 803 prepared to allow the user to easily select operations provided by the menu. Further, the variable data printing editor 800 includes a scroll bar 804 for scrolling the window and editing the entire document page, and a combo box 809 for designating the operation mode of the variable data printing editor 800.

The variable data printing editor 800 runs when the user designates either of two modes “normal edit mode” and “overall edit mode”. The operation of the variable data printing editor 800 in the normal edit mode will be explained. As shown in FIG. 8, the user designates the “normal edit mode” in the combo box 809. The window displays a document page 805 to be edited by the variable data printing editor 800. When moving to another one, the user may select “page move function” from the menu bar 802.

Variable fields 806 and 807 are laid out on the document page 805. In the embodiment, the variable fields 806 and 807 are created when the user selects a “variable field creation function” from the menu bar 802 or tool button 803 and renders a rectangular area with the mouse or the like. In FIG. 8, text data is inserted into the variable field 806, and image data is inserted into the variable field 807. When the user sets the variable fields 806 and 807 on the document page 805, data in the database are inserted into them.

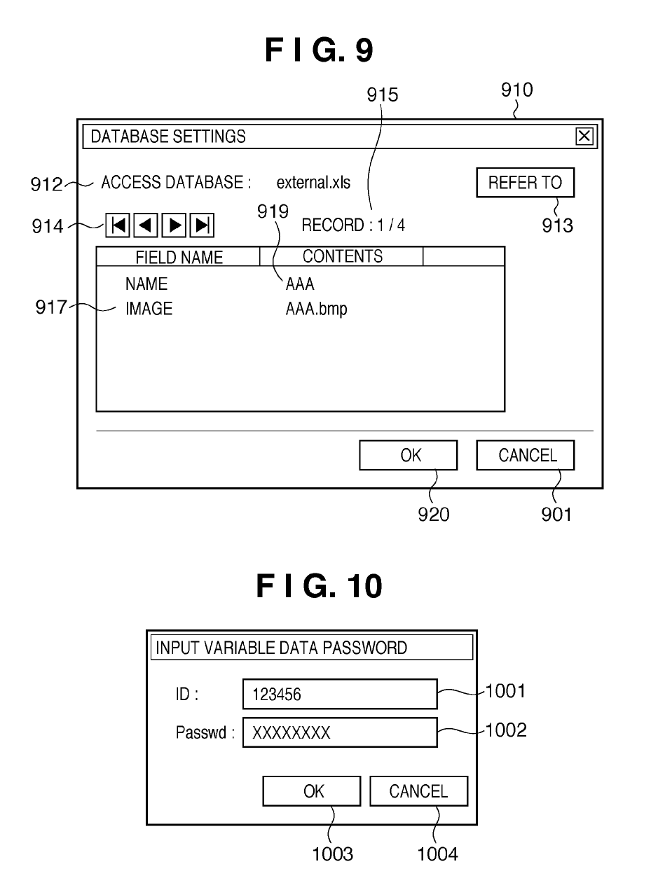

FIG. 9 is a view showing an example of a user interface used to access the database. An access dialog 910 shown in FIG. 9 may also be displayed using the menu bar 802 or tool button 803 shown in FIG. 8. As shown in FIG. 9, a display portion 912 displays the file name of the currently accessed external database 105a. When the user does not access the external database 105a, the display portion 912 is blank. When accessing the external database 105a, the user presses a button 913 to display a database file reference dialog (not shown) or the like. The user can select a file name in a desired database from the database file reference dialog or the like.

A case where the user needs to be authenticated by a password for accessing the external database 105a will be explained. FIG. 10 is a view showing an example of a dialog displayed when password-based authentication is necessary. The user inputs a user ID to an input portion 1001 in the dialog shown in FIG. 10, inputs a password to an input portion 1002, and presses a button 1003 to access the external database 105a. The user presses a button 1004 to disconnect the database.

Referring back to FIG. 9, when the user accesses the external database 105a by this operation, a display portion 915 displays the total number of records entered in the accessed database and the number of a currently displayed record. A display portion 917 displays the database field name of a record corresponding to the display portion 915, and a display portion 919 displays variable data corresponding to the database field name. For example, the database field name “name” having variable data “AAA”, and the database field name “image” having variable data “AAA.bmp” are displayed in FIG. 9. The user can use a button 914 to display a record of a non-displayed number. By this operation, while accessing the external database 105a, the user can use the button 913 to select another database and switch the access. In this case, password-based authentication can be executed again by the dialog shown in FIG. 10.

After pressing a button 920 to finalize the external database 105a to be accessed, the user associates the variable field 806 on the document page 805 with variable data in the external database 105a. For example, the user may also associate a variable field with variable data in the external database by displaying the properties of the variable field 806 or 807 shown in FIG. 8 and selecting a database field name.

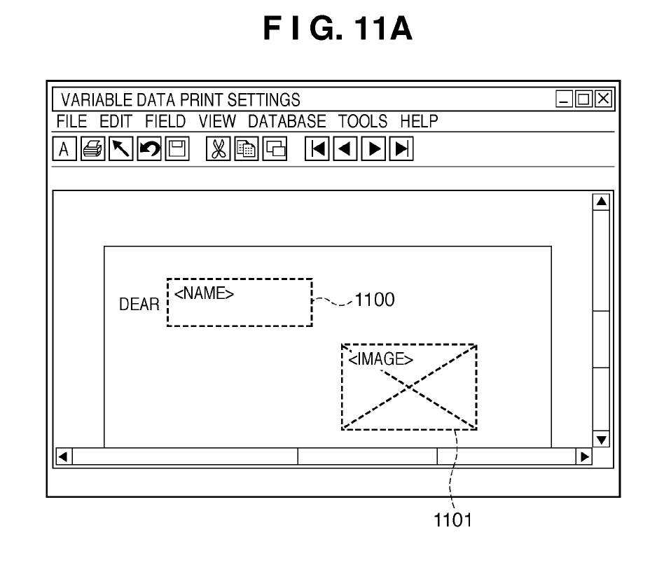

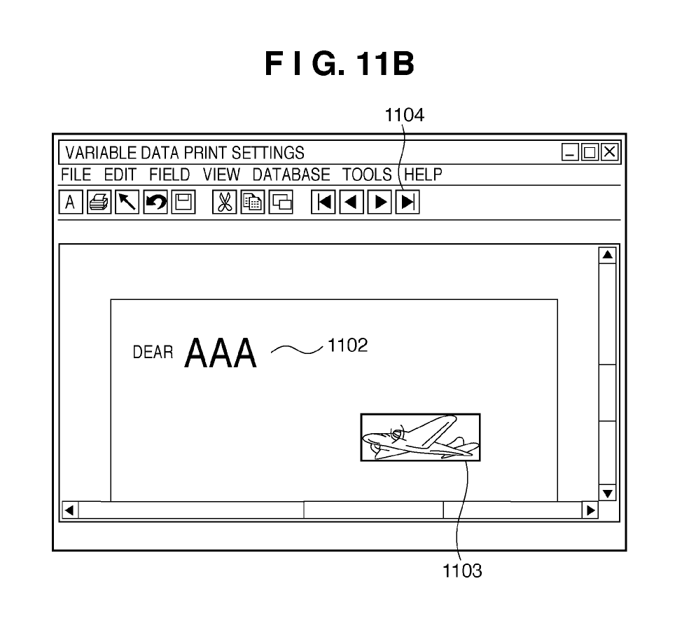

FIGS. 11A and 11B are views showing the concept of associating a variable field on a document page with data in an external database. In FIG. 11A, by the above-described operation, the database field name “name” is associated with a variable field 1100, and the database field name “image” is associated with a variable field 1101. For example, when the user previews associated contents by using the menu bar or the like, he can check the state in which data in the external database is inserted into a document page, as shown in FIG. 11B.

In FIG. 11B, text variable data 1102 is inserted into the variable field 1100, and image variable data 1103 is inserted into the variable field 1101. When the user changes the displayed record by using a button 1104, a preview image corresponding to the record is output and displayed.

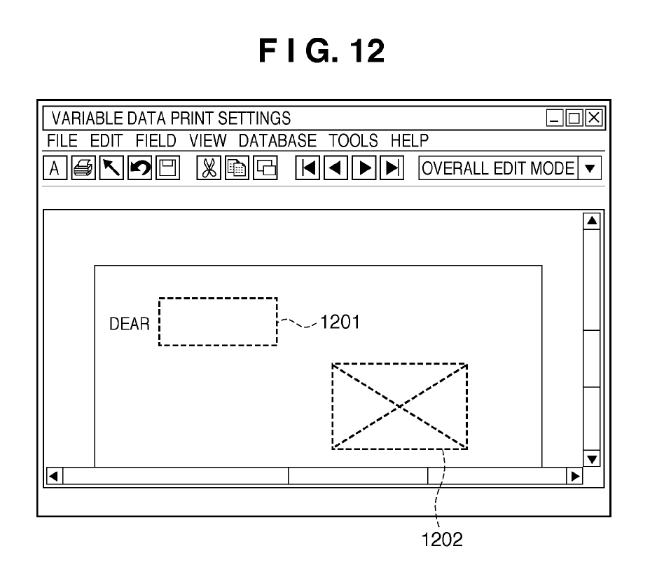

The operation of the variable data printing editor 800 in the overall edit mode will be explained. FIG. 12 is a view showing an example of the user interface of the variable data printing editor when the user selects the “overall edit mode” in the combo box 809. In FIG. 12, maximum rectangular areas 1201 and 1202 are defined for all variable data associated with variable fields.

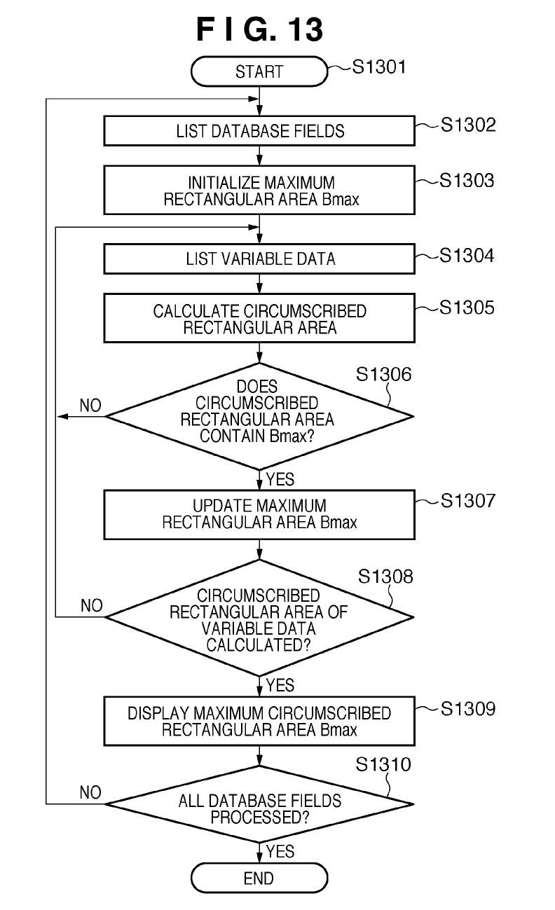

A display operation in the “overall edit mode” will be described with reference to FIGS. 1A, 1B, and 2. FIG. 13 is a flowchart chart showing a processing sequence in the overall edit mode.

Assume that the hard disk 211 stores the printing application 104, the electronic document file 103, and a database 105a. Also assume that the printing application 104 has already run, and the user designates a desired document page 603 on the user interface window 600, sets a variable field, and associates it with variable data in the external database 105a.

In step S1301, the variable data printing editor 800 starts by a user input operation, and the user designates the “overall edit mode”. In step S1302, the CPU 201 lists all variable data associated with all variable fields on a document page for each database field. In step S1303, the CPU 201 ensures a maximum rectangular area Bmax which contains a rectangular area circumscribing variable data, and initializes it by clearing the Bmax value to 0.

In step S1304, the CPU 201 arranges and lists variable data of the database field in accordance with, for example, the data table structure. In step S1305, the CPU 201 calculates a circumscribed rectangular area for the first one of the listed variable data. In step S1306, the CPU 201 compares the circumscribed rectangular area calculated in step S1305 with data represented by the maximum circumscribed rectangular area Bmax. If the circumscribed rectangular area calculated in step S1305 covers the value represented by the maximum circumscribed rectangular area Bmax, the CPU 201 updates the value of the maximum circumscribed rectangular area Bmax to the circumscribed rectangular area calculated in step S1305. In this case, the CPU 201 updates the value of the maximum circumscribed rectangular area Bmax by coordinate information of two points of the diagonal of the rectangular area, as shown in FIG. 5E. If the circumscribed rectangular area calculated in step S1305 does not cover the value represented by the maximum circumscribed rectangular area Bmax, the CPU 201 refers to the next variable data to repeat steps S1304 to S1306.

In step S1308, the CPU 201 determines whether the circumscribed rectangular areas of all variable data in a specific database field have been calculated. If the CPU 201 determines that the circumscribed rectangular areas of all variable data have not been calculated, it repeats steps S1304 to S1308. If the CPU 201 determines that the circumscribed rectangular areas of all variable data have been calculated, the process advances to step S1309. In step S1309, the circumscribed rectangular area contained in the maximum circumscribed rectangular area Bmax is stored in another register, memory, or the like, and used for display by the printing application 104 (an example of a maximum area generation unit in the embodiment).

In step S1310, the CPU 201 determines whether the processes in steps S1302 to S1309 have ended for all database fields. If NO in step S1310, the CPU 201 repeats steps S1302 to S1310 for the next database field.

After the end of the process of the flowchart shown in FIG. 13, a variable data rectangular area having a maximum circumscribed rectangular area is displayed in each variable field on a document page (an example of a maximum area display control unit in the embodiment).

As described above, according to the embodiment, when editing the layout of pages of document data, the user can check a maximum circumscribed rectangular area for variable data in each variable field at once. Steps for displaying variable data for each record and checking the circumscribed rectangular area can be omitted, greatly reducing the number of steps for editing the style of an entire page.

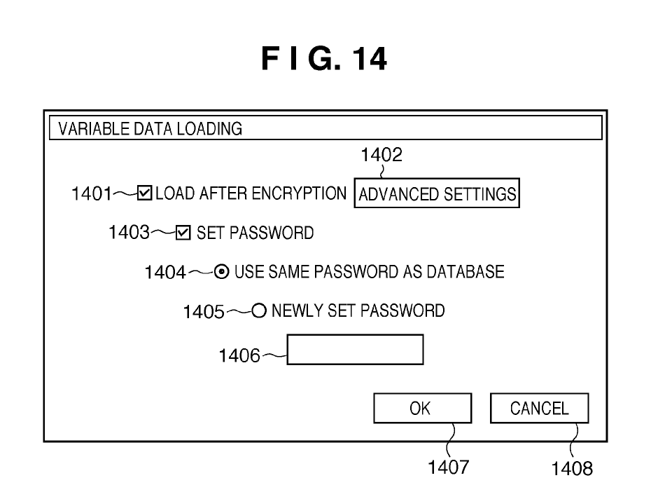

In the embodiment, when loading variable data into an electronic document file, the variable data can be encrypted and an authentication password can be set. FIG. 14 is a view showing an example of a dialog displayed when loading variable data into an electronic document file. As shown in FIG. 14, when the user checks a check box 1401, the variable data printing editor 800 encrypts variable data and loads it into the electronic document file 103. The user can use a button 1402 to display a user interface (not shown) and make encryption settings such as the cipher system and encryption strength. When the user checks a check box 1403, the variable data printing editor 800 sets an authentication password for encrypted variable data. In this case, if the user checks a check box 1404, a password set by him in FIG. 10 is automatically set. If the user checks a check box 1405, a password input to an input portion 1406 is set.

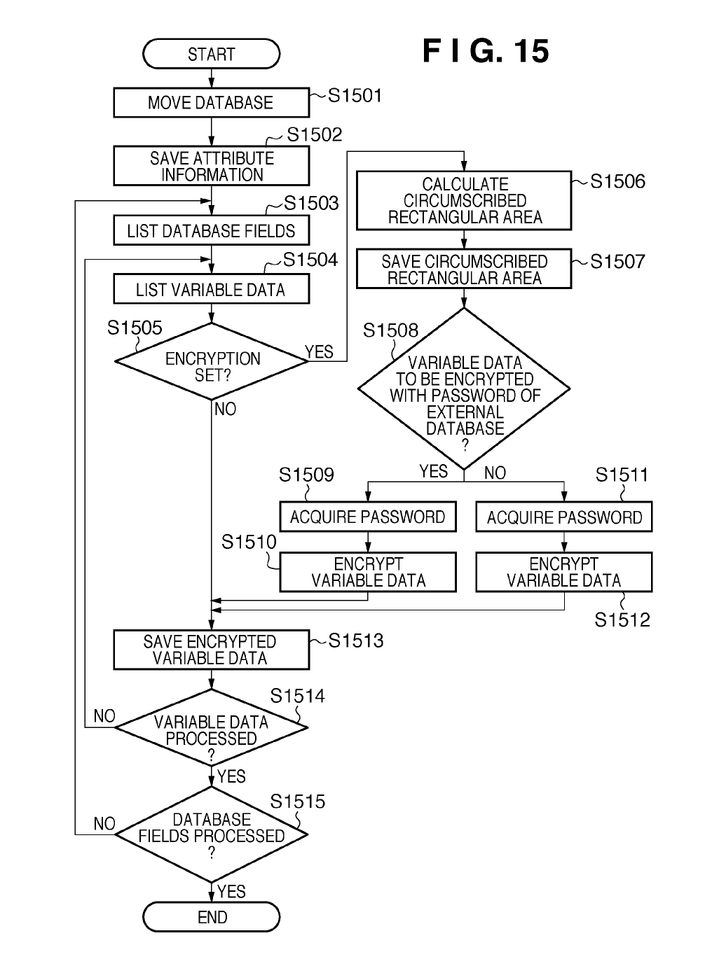

The user can use a button 1407 shown in FIG. 14 to finalize these data, and a button 1408 to cancel data settings. FIG. 15 is a flowchart showing a processing sequence to encrypt variable data and set an authentication password. Assume that the user sets data in the dialog shown in FIG. 14 and presses the button 1407. Then, in step S1501, the CPU 201 moves the external database 105a represented by the area 504 shown in FIG. 5A to, e.g., the electronic document file 103 in the hard disk 211. That is, variable data in the external database 105a are stored in the area 504 shown in FIG. 5A. The stored external database 105a will be referred to as the internal database 105b to discriminate it from the external database 105a.

After that, the CPU 201 reads out or writes data from or in the internal database 105b. In step S1502, the CPU 201 writes and saves various attributes in the data tables of the electronic document file 103 in FIGS. 5A to 5F in accordance with contents set by the user.

For example, information of the check box 1401 in FIG. 14 is written in the area 501 shown in FIG. 5A, and ID information of the input portion 1001 in FIG. 10 is written in the area 502. If the check box 1404 in FIG. 14 is checked, password information of the input portion 1002 in FIG. 10 is written in the area 503. If the check box 1405 is checked, password information of the input portion 1406 is written in the area 503. Database information moved to the electronic document file 103 is written in the area 504.

In step S1503, the CPU 201 arranges and lists data of the moved database for each database field. In step S1504, the CPU 201 arranges and lists variable data of the database field in accordance with, for example, the data table structure. In step S1505, the CPU 201 determines information of the area 501 shown in FIG. 5A. If the CPU 201 determines from the information of the area 501 that encryption of variable data is not set, the process advances to step S1513. If the CPU 201 determines that encryption of variable data is set, the process advances to step S1506.

In step S1506, a rectangular area circumscribing each variable data in a specific database field is calculated. In general, when variable data is text data, header information of the data file or the like includes font attribute information, and the CPU 201 may also acquire this information. Also when variable data is image data, header information of the image file or the like includes data size information, and the CPU 201 may also acquire this information. When variable data is a character string, it is also possible to calculate the circumscribed rectangular area of the entire character string or the circumscribed rectangular area of each character of the entire character string.

In step S1507, the CPU 201 writes the circumscribed rectangular area calculated in step S1506 in the area 511 shown in FIG. 5B. In step S1508, the CPU 201 determines whether password information written in the area 503 shown in FIG. 5A coincides with a password used for authentication when the user accesses the external database 105a. This determination may also be made by comparing the password information by the CPU 201 with a password set by the user to access the external database 105a.

If the CPU 201 determines in step S1508 that the password written in the area 503 coincides with one for accessing the external database 105a, the process advances to step S1509.

The CPU 201 acquires, from the area 503, the password for accessing the external database 105a in step S1509, and encrypts variable data by using the password in step S1510. If the CPU 201 determines in step S1508 that the password written in the area 503 is different from one for accessing the external database 105a, the process advances to step S1511. The CPU 201 acquires, from the area 503, a password input to the input portion 1406 shown in FIG. 14 in step S1511, and encrypts variable data by using the password in step S1512. In step S1513, the variable data encrypted with the password is written in the area 504 shown in FIG. 5A. If the CPU 201 determines in step S1514 that all variable data have not been processed, it repeats steps S1504 to S1514. If the CPU 201 determines in step S1515 that all database fields have not been processed, it repeats steps S1503 to S1515.

In the embodiment, a password is necessary to decrypt encrypted variable data later, so the encrypted contents can be decrypted by only an authenticated password. In the embodiment, a password is set when moving the contents of the external database 105a to the electronic document file 103. Thus, even if the user moves the electronic document file containing variable data to another network segment, he can edit the electronic document file by using an authenticated password.

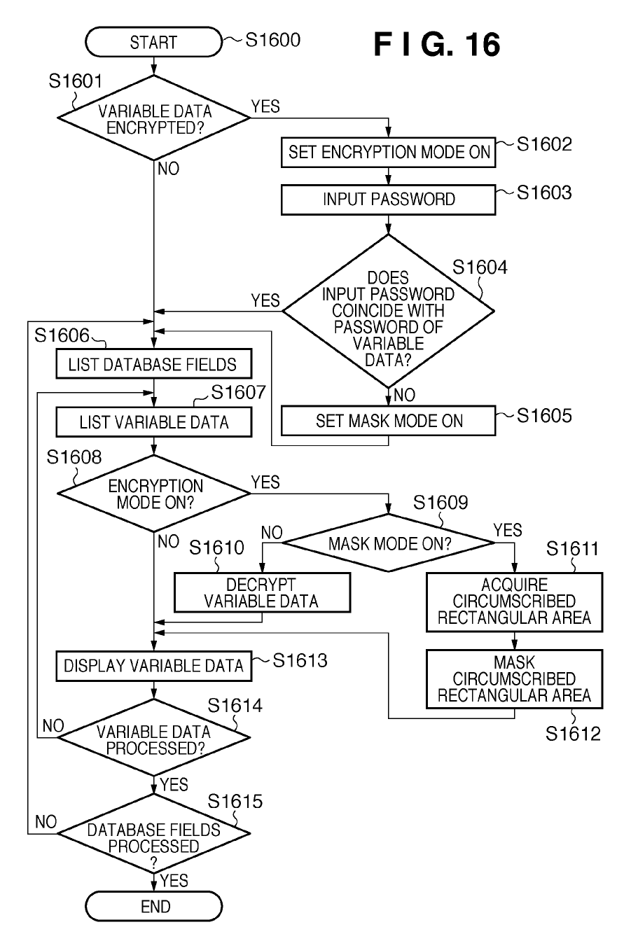

Processing when the printing application 104 displays the electronic document file 103 containing variable data encrypted in accordance with the flowchart shown in FIG. 15 will be explained. FIG. 16 is a flowchart showing a processing sequence when displaying the electronic document file 103 containing encrypted variable data. Assume that the user opens the electronic document file 103 on the user interface window 600 of the printing application 104.

In step S1601, the CPU 201 refers to, for example, information written in the area 501 shown in FIG. 5A to determine whether variable data is encrypted. If the CPU 201 determines that no variable data is encrypted, the process advances to step S1606. If the CPU 201 determines that variable data is encrypted, the process advances to step S1602 to set the encryption mode ON. The CPU 201 may also set the encryption mode ON when a flag implemented by part of the area 501 is “1”, and OFF when the flag is “0”.

In step S1603, the user inputs a password. In the embodiment, when the user is to open the electronic document file 103, the dialog as shown in FIG. 10 automatically appears. In step S1604, the CPU 201 compares the password input by the user with one set for the variable data.

If the password input by the user does not coincide with one set for the variable data, the process advances to step S1605 to set the mask mode ON. The CPU 201 may also set the mask mode ON when a flag implemented by part of the area 501 is “1”, and OFF when the flag is “0”. If the password input by the user coincides with one set for the variable data, the process advances to step S1606.

In step S1606, the CPU 201 arranges and lists variable data for each database field, similar to step S1503 shown in FIG. 15. In step S1607, the CPU 201 arranges and lists variable data, similar to step S1504 shown in FIG. 15. In step S1608, the CPU 201 detects the encryption mode ON/OFF state set in step S1602. If the encryption mode is OFF, the process advances to step S1613 to display variable data. If the encryption mode is ON, the process advances to step S1609 to detect the mask mode ON/OFF state set in step S1605. If the mask mode is ON, the process advances to step S1611, and the CPU 201 acquires a circumscribed rectangular area written in the area 511 shown in FIG. 5B. In step S1612, the CPU 201 masks an area determined by the acquired circumscribed rectangular area, and displays the area while hiding the data contents (step S1613). If the mask mode is OFF, the process advances to step S1610, and the CPU 201 decrypts the variable data by using the password input in step S1603 and displays the decrypted variable data in step S1613.

Similar to step S1514 in FIG. 15, if the CPU 201 determines in step S1614 that all variable data have not been processed, it repeats steps S1607 to S1614. Similar to step S1515 in FIG. 15, if the CPU 201 determines in step S1615 that all database fields have not been processed, it repeats steps S1606 to S1615.

As described above, according to the embodiment, even if no password is authenticated when the user is to open the electronic document file 103, variable data whose circumscribed rectangular area is masked is displayed. Even an unauthenticated user can edit the style of an entire document based on masked variable data. This can increase the workflow efficiency of variable data printing in which a plurality of operators engage.

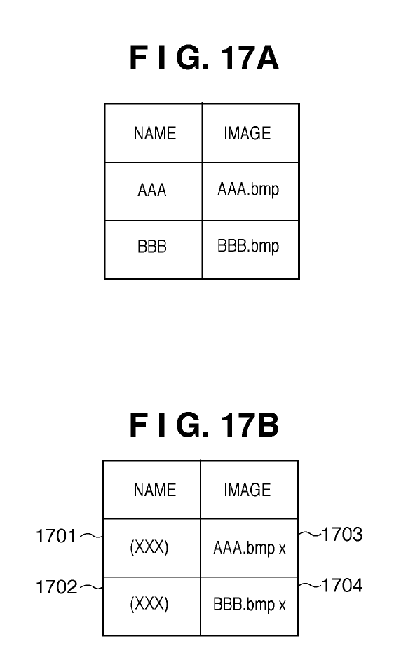

Based on the above description, the embodiment will be explained. In the embodiment, the external database 105a exists outside the electronic document file 103, as shown in FIG. 1A. In the embodiment, the external database 105a has a structure as shown in FIG. 17A. FIG. 17B shows the structure of the internal database 105b. More specifically, variable data “AAA” and “BBB” are entered in a database field identified by “name”. Variable data “AAA.bmp” and “BBB.bmp” are entered in a database field identified by “image”.

In the embodiment, the user accesses the external database 105a by using an ID “123456” and password “abcdef”. In this case, the name of a database to be accessed is “external.xls” displayed at the display portion 912 shown in FIG. 9. Data set when loading variable data from the external database 105a into the electronic document file 103 in accordance with the flowchart of FIG. 15 complies with the contents shown in FIG. 14. As described with reference to FIG. 15, the database “external.xls” is moved to the electronic document file 103. The moved database will be called “local.csv”.

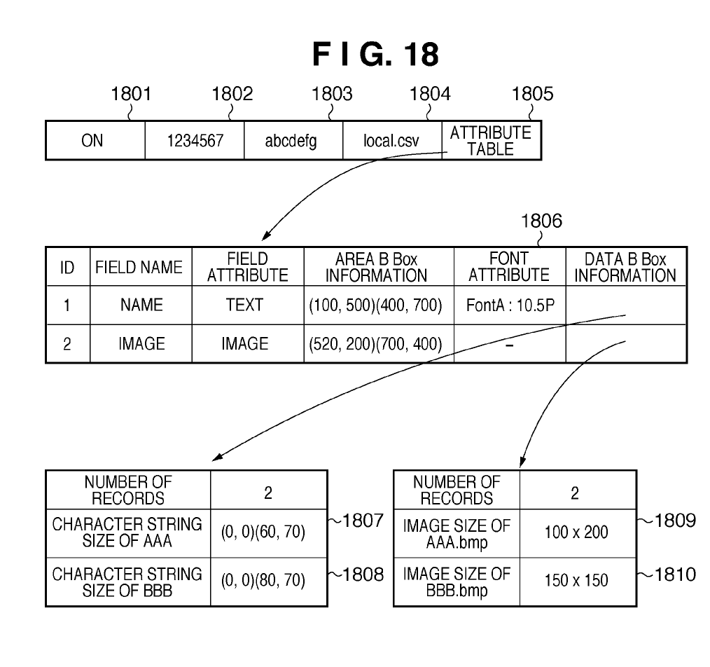

This processing will be explained with reference to the flowchart shown in FIG. 15. In step S1502, the CPU 201 saves attribute information in accordance with contents set by the user, as shown in FIG. 18. In the embodiment, encryption information, an ID, and a password are written in areas 1801 to 1803 shown in FIG. 18. “local.csv” stored in an area 1804 represents the internal database 105b. In step S1503, the CPU 201 lists a database field identified by “name” in “local.csv”. In step S1504, the CPU 201 lists all variable data in the database field identified by “name”. In this case, two records “AAA” and “BBB” are listed.

In step S1505, the CPU 201 determines whether encryption of the first record “AAA” is set. Since encryption of “AAA” is set in the embodiment, the CPU 201 calculates a rectangular area circumscribing the character string “AAA” in step S1506 (an example of the circumscribed area generation unit in the embodiment). The circumscribed rectangular area circumscribes the character string “AAA” in a font represented by a font attribute “FontA: 10.5P” written in an area 1806 shown in FIG. 18. In step S1507, the CPU 201 writes the calculated rectangular area data in an area 1807 shown in FIG. 18.

In step S1508, the CPU 201 determines the type of password. In the embodiment, a password for accessing the external database 105a is used to encrypt variable data. In step S1513, the CPU 201 writes the encrypted variable data in an area 1701 shown in FIG. 17B. In step S1514, the CPU 201 determines whether listing of variable data has ended. Then, the process returns to step S1504 to list the next record “BBB”. The CPU 201 determines in step S1505 whether encryption of the record “BBB” is set, and calculates the circumscribed rectangular area of the character string “BBB” in step S1506. In step S1507, the CPU 201 writes the calculated circumscribed rectangular area in an area 1808 shown in FIG. 18. The CPU 201 determines the type of password in step S1508, and in step S1510, encrypts the variable data by using the password for accessing the external database 105a. In step S1513, the CPU 201 writes the encrypted variable data in an area 1702 shown in FIG. 17B. After processing the character string “BBB”, the CPU 201 determines in step S1514 that listing of variable data has ended. Then, the process advances to step S1515.

In step S1515, the CPU 201 determines that listing of database fields has not ended, and returns to step S1503 to list a database field recognized by “image”. In step S1504, the CPU 201 lists variable data for the database field recognized by “image”. In this case, “AAA.bmp” is listed first in step S1504. The CPU 201 determines in step S1505 whether encryption of “AAA.bmp” is set, and calculates the circumscribed rectangular area of the variable data “AAA.bmp” in step S1506. In step S1507, the CPU 201 writes the calculated circumscribed rectangular area data in an area 1809. The CPU 201 determines the type of password in step S1508, and in step S1510, encrypts the variable data by using the password for accessing the external database 105a.

In step S1513, the CPU 201 encrypts the entire image file of the encrypted image data, and writes the file name in an area 1703. In step S1514, the CPU 201 determines that listing of variable data has not ended. Then, the process returns to step S1504 to list the next variable data “BBB.bmp”. The CPU 201 determines in step S1505 whether encryption of “BBB.bmp” is set, and calculates the circumscribed rectangular area of “BBB.bmp” in step S1506. In step S1507, the CPU 201 writes the calculated circumscribed rectangular area data in an area 1810. In step S1510, the CPU 201 encrypts the variable data by using the password for accessing the external database 105a. In step S1513, the CPU 201 encrypts the entire image file of the image data, and writes the file name in an area 1704.

In step S1514, the CPU 201 determines that all variable data have been listed, and the process advances to step S1515. In step S1515, the CPU 201 determines that all database fields have been listed, and ends the process. After all the processes end, the data table of the variable data printing item 401 of the electronic document file 103 has contents as shown in FIG. 18. “ON” is written in the area 1801 to represent that data is encrypted, and an ID “1234567” for accessing the external database 105a is written in the area 1802. The password “abcdefg” for accessing the external database 105a is written in the area 1803.

“local.csv” representing the internal database 105b moved from the external database 105a to the electronic document file is stored in the area 1804. The attribute field for database fields in an area 1805 includes two database fields identified by “ID1” and “ID2”. The database field “ID1” is identified by the database field name “name”, and has the field attribute “text”. A rectangular area whose diagonal is a line connecting coordinate points (100, 500) and (400, 700) is described as a variable field. The database field “ID1” has a text with the font attribute “FontA: 10.5P”.

Similarly, the database field “ID2” is identified by the database field name “image”, and has the field attribute “image”. A rectangular area whose diagonal is a line connecting coordinate points (520, 200) and (700, 400) is defined as a variable field. Since the field attribute is “image”, no font attribute is defined. Two records of character strings “AAA” and “BBB” are entered in the circumscribed rectangular area of variable data in the database field “ID1”.

A rectangular area whose diagonal is a line connecting coordinate points (0, 0) and (60, 70) described in the area 1807 is defined as the circumscribed rectangular area of the character string “AAA”. Also, a rectangular area whose diagonal is a line connecting coordinate points (0, 0) and (80, 70) described in the area 1808 is defined as the circumscribed rectangular area of the character string “BBB”. Two records of image data “AAA.bmp” and “BBB.bmp” are entered in the circumscribed rectangular area of variable data in the database field “ID2”. The image size of “AAA.bmp” is “100×200”, as shown in the area 1809, and that of “BBB.bmp” is “150×150”, as shown in the area 1810.

“(XXX)” in each of the areas 1701 and 1702 shown in FIG. 17B represents an encrypted character string. “ . . . .bmpx” in each of the areas 1703 and 1704 shown in FIG. 17B represents the extension of the name of an encrypted image file. FIG. 1B shows a configuration in which the external database 105a is moved as “local.csv” to the electronic document file 103.

Processing when opening the electronic document file 103 will be explained with reference to FIG. 16. The user opens the electronic document file 103 (step S1600), and the CPU 201 determines in step S1601 whether variable data of the electronic document file 103 is encrypted. In the embodiment, encryption information in the area 1801 is “ON”, so the CPU 201 sets the encryption mode ON in step S1602. Then, a password input window as shown in FIG. 10 appears (step S1603). In step S1603, the user inputs an ID and password. If the password coincides with contents written in the area 1803 in step S1604, the CPU 201 determines that the password has been authenticated, and the process advances to step S1606. If the CPU 201 determines in step S1604 that no password has been authenticated, the process advances to step S1605 to set the mask mode ON.

A case where an unauthenticated operator opens a document page will be described. More specifically, no password is authenticated and the mask mode is set ON. In step S1606, the CPU 201 lists database fields. In the embodiment, the CPU 201 lists two database fields recognized by “name” and “image”.

First, the CPU 201 lists variable data “AAA” and “BBB” for the database field “name” (step S1607). In the embodiment, variable data “AAA” is listed first.

The CPU 201 determines in step S1608 that the encryption mode is ON, and determines the mask mode in step S1609. In the embodiment, since the mask mode is ON, the CPU 201 acquires the circumscribed rectangular area of the character string “AAA” from the area 1807 in step S1611. The CPU 201 masks the inside of the circumscribed rectangular area in step S1612, and displays a window in step S1613.

In step S1614, the CPU 201 determines whether all variable data have been processed. Since the next variable data “BBB” has not been processed, the process returns to step S1607 to list the variable data “BBB”. The CPU 201 determines in step S1608 that the encryption mode is ON, and determines in step S1609 that the mask mode is ON. In step S1611, the CPU 201 acquires the circumscribed rectangular area of “BBB” from the area 1808. The CPU 201 masks the inside of the circumscribed rectangular area in step S1612, and displays a window in step S1613.

In step S1614, the CPU 201 determines whether all variable data have been processed. In this case, the CPU 201 determines that all variable data have been processed, and the process advances to step S1615. In step S1615, a database field recognized by “image” has not been processed, so the process returns to step S1606 to list the database field recognized by “image”.

In step S1607, the CPU 201 lists variable data “AAA.bmpx”. The CPU 201 determines in step S1608 that the encryption mode is ON, and determines in step S1609 that the mask mode is ON. In step S1611, the CPU 201 acquires the circumscribed rectangular area of the variable data “AAA.bmpx” from the area 1809. The CPU 201 masks the inside of the circumscribed rectangular area in step S1612, and displays a window in step S1613. In step S1614, the CPU 201 determines that all variable data have not been processed. In step S1607, the CPU 201 lists the next variable data “BBB.bmpx”. The CPU 201 determines in step S1608 that the encryption mode is ON, and determines in step S1609 that the mask mode is ON.

In step S1611, the CPU 201 acquires the circumscribed rectangular area of “BBB.bmpx” from the area 1810. The CPU 201 masks the inside of the circumscribed rectangular area in step S1612, and displays a window in step S1613. In step S1614, the CPU 201 determines that all variable data have been processed. In step S1615, the CPU 201 determines that all database fields have been listed, and the process ends.

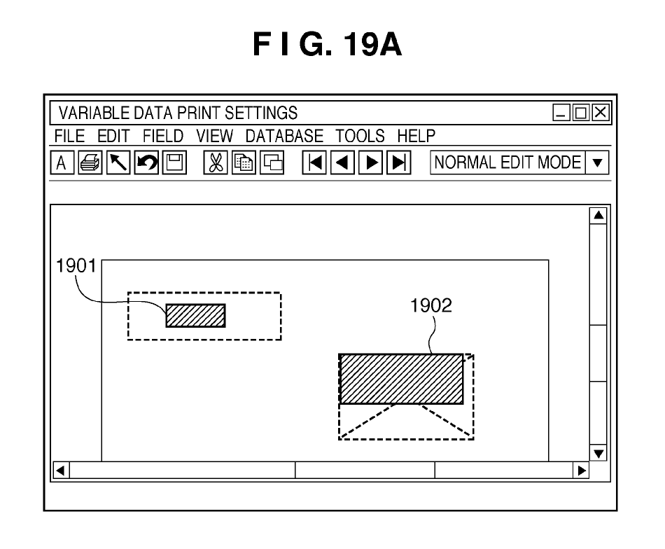

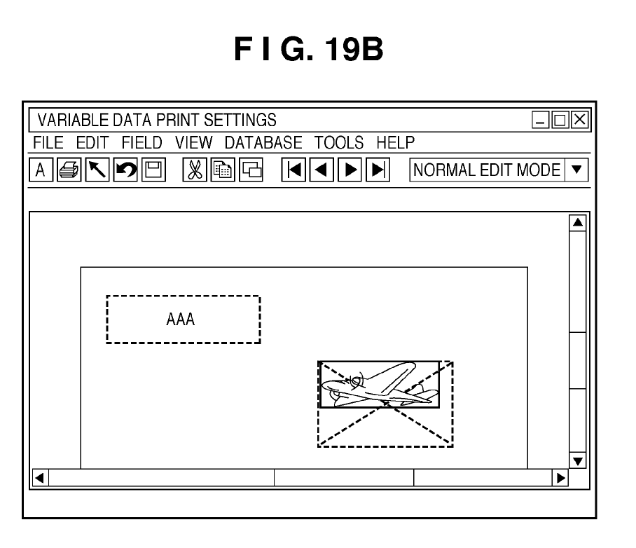

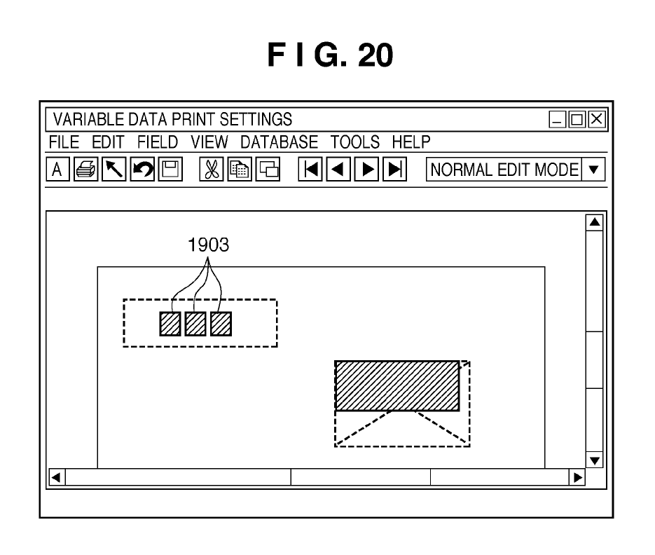

FIGS. 19A and 19B are views showing examples of a window displayed at the end of the process of the flowchart shown in FIG. 16. As shown in FIG. 19A, a circumscribed rectangular area 1901 is the circumscribed rectangular area of masked variable data “AAA”, and a circumscribed rectangular area 1902 is the circumscribed rectangular area of masked variable data “AAA.bmpx”. In FIG. 19A, the circumscribed rectangular areas of “BBB” and “BBB.bmpx” can be displayed by, for example, pressing the record move button of the variable data printing editor 800. When the encryption mode is OFF or the mask mode is OFF in the flowchart shown in FIG. 16, variable data is displayed without masking it, as shown in FIG. 19B. In the embodiment, when the circumscribed rectangular area is calculated for each character of a character string, a window as shown in FIG. 20 appears (an example of a display control unit in the embodiment).

In the embodiment, even when a user having no authorization to browse data designates display of an electronic document file, a page in which circumscribed rectangular areas are laid out at the positions of variable fields can be displayed.

Each circumscribed rectangular area 1903 is masked for each character. As described above, even when the contents of variable data are hidden on the window, they are displayed as a circumscribed rectangular area, and the user can edit the style to, for example, enlarge/reduce each variable field. This can increase the workflow efficiency of variable data printing in which a plurality of operators engage.

A case where a window is displayed in the “overall edit mode” according to the embodiment will be explained. The user activates the variable data printing editor 800 in the “overall edit mode” for an electronic document whose variable data are encrypted, as shown in FIG. 12. This processing will be described with reference to the flowchart of FIG. 13.

In step S1301, the variable data printing editor 800 starts up in the overall edit mode. When opening the electronic document file 103 in the overall edit mode, the user inputs an ID and password. In the following description, assume that a password input by the user is not authenticated when opening the electronic document file in the overall edit mode.

In step S1302, the CPU 201 lists database fields. In this case, the CPU 201 lists two database fields recognized by “name” and “image” shown in FIG. 11A. In the embodiment, the CPU 201 lists the database field identified by “name” first.

The CPU 201 initializes the maximum circumscribed rectangular area Bmax in step S1303 by clearing the Bmax value to 0, and lists variable data “AAA” and “BBB” in step S1304. In step S1304, the CPU 201 lists “AAA” first, and acquires the circumscribed rectangular area of “AAA” from the area 1807. The circumscribed rectangular area acquired from the area 1807 is a rectangular area whose diagonal is a line connecting coordinate points (0, 0) and (60, 70). In step S1306, the CPU 201 detects that the maximum circumscribed rectangular area Bmax has been initialized. In step S1307, the CPU 201 stores the circumscribed rectangular area of the variable data “AAA” in the maximum circumscribed rectangular area Bmax.

The CPU 201 determines in step S1308 that listing of variable data has not ended, and lists the next variable data “BBB” in step S1304. In step S1305, the CPU 201 acquires the circumscribed rectangular area of “BBB” from the area 1808. The acquired circumscribed rectangular area is a rectangular area whose diagonal is a line connecting coordinate points (0, 0) and (80, 70). In step S1306, the CPU 201 compares the circumscribed rectangular area of the variable data “BBB” with the value represented by the maximum circumscribed rectangular area Bmax, that is, the circumscribed rectangular area of “AAA”.

Since the x-coordinate “80” of the coordinate point of the diagonal of the circumscribed rectangular area of “BBB” is larger than the x-coordinate “60” of the coordinate points of the diagonal of Bmax, the CPU 201 updates Bmax to the x-coordinate of the coordinate point of the diagonal of the circumscribed rectangular area of “BBB” (step S1307). As a result, the maximum circumscribed rectangular area Bmax is updated to a rectangular area whose diagonal is a line connecting coordinate points (0, 0) and (80, 70).

In step S1309, the CPU 201 displays the maximum circumscribed rectangular area Bmax in the variable field. The CPU 201 determines in step S1310 that listing of database fields has not ended, and lists the database field recognized by “image” in step S1302. The CPU 201 initializes the maximum circumscribed rectangular area Bmax in step S1303, and lists variable data in step S1304.

The CPU 201 lists “AAA.bmpx” first, and acquires a circumscribed rectangular area from the area 1809 in step S1305. The maximum circumscribed rectangular area Bmax has been initialized in step S1303. In step S1306, the circumscribed rectangular area calculated in step S1305 is determined to cover the value represented by the maximum circumscribed rectangular area Bmax. The CPU 201 updates Bmax to a circumscribed rectangular area “100×200” described in the area 1809 in step S1307. The CPU 201 determines in step S1308 that listing of variable data has not ended, and lists “BBB.bmpx” in step S1304. The CPU 201 acquires the circumscribed rectangular area of “BBB.bmpx” from the area 1810 in step S1305, and compares it with the value represented by Bmax in step S1306. Since the width “150” of the circumscribed rectangular area of “BBB.bmpx” is larger than the width “100” of the circumscribed rectangular area of “AAA.bmp” represented by Bmax, the CPU 201 updates the maximum circumscribed rectangular area Bmax to the larger width. Hence, Bmax is updated to the size “150×200” in step S1307. The CPU 201 determines in step S1308 that listing of variable data has ended, and displays a circumscribed rectangular area having the size of the maximum circumscribed rectangular area Bmax. In step S1310, the CPU 201 determines that listing of all database fields has ended, and the process ends.

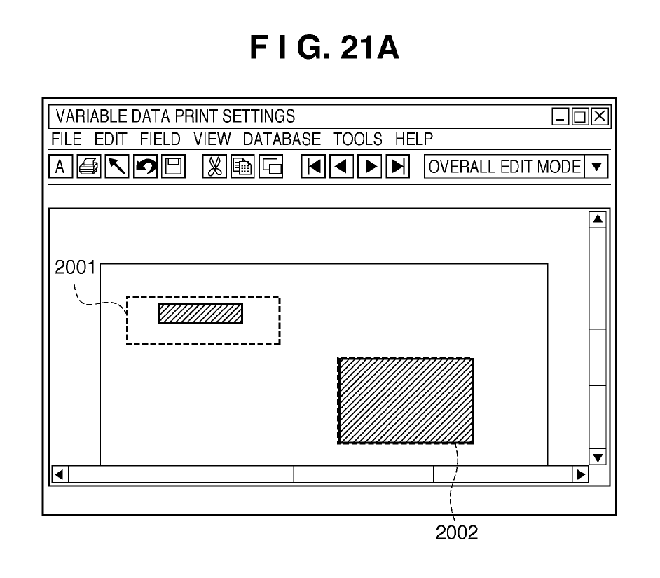

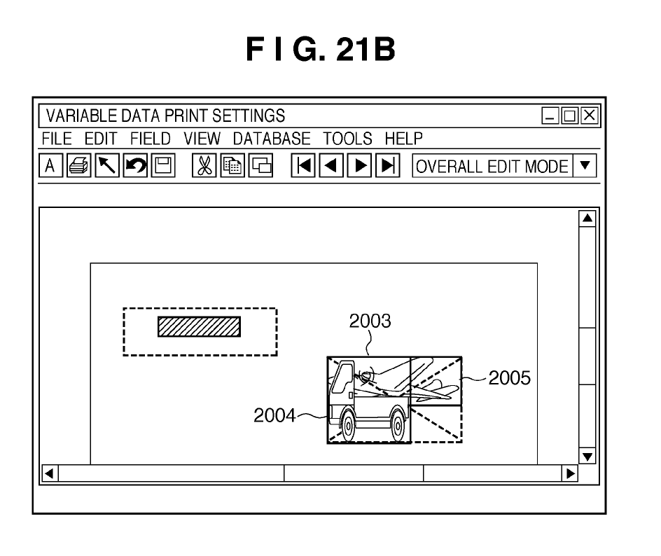

FIG. 21A is a view showing an example of a window displayed at the end of the process of the flowchart shown in FIG. 13. As shown in FIG. 21A, a circumscribed rectangular area 2001 is a rectangular area whose diagonal is a line connecting coordinate points (0, 0) and (80, 70) obtained by overlaying the circumscribed rectangular areas of variable data “AAA” and “BBB”. A circumscribed rectangular area 2002 is a rectangular area having a size “150×200” obtained by overlaying the circumscribed rectangular areas of variable data “AAA.bmpx” and “BBB.bmpx”.

FIG. 21B shows the concept of displaying the maximum circumscribed rectangular area Bmax in a circumscribed rectangular area 2003. As shown in FIG. 21B, the circumscribed rectangular area 2003 is obtained by overlaying a circumscribed rectangular area 2004 of “AAA.bmpx” having a size of 100×200, and a circumscribed rectangular area 2005 of “BBB.bmpx” having a size of 150×150.

If a password input by the user is authenticated when opening an electronic document file in the overall edit mode, the window may also be provided, as shown in FIG. 21B.

As described above, even when the user cannot see the contents of variable data on an electronic document file, the maximum circumscribed rectangular area of variable data in each variable field is displayed. Even a user whose password is not authenticated can edit the style of an entire document by, for example, enlarging or reducing variable fields laid out on a document page.

The present invention also includes a case where an OS (Operating System) or the like running on a computer performs part or all of actual processing based on the instructions of program codes (information processing program) and thereby implements the functions of the above-described embodiment. The present invention is also applied to a case where program codes read out from a storage medium are written in the memory of a function expansion card inserted into the computer or the memory of a function expansion unit connected to the computer. In this case, the CPU of the function expansion card or function expansion unit performs part or all of actual processing based on the instructions of the written program codes, thereby implementing the functions of the above-described embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Laid-Open No. 2007-156735, filed Jun. 13, 2007 which is hereby incorporated by reference herein in its entirety.

What is claimed is:

1. An information processing apparatus which outputs a preview image when inserting data stored in a database into an area designated by a template on a page that forms document data, and outputting the data, the apparatus comprising:
a circumscribed area generation unit configured to generate a circumscribed area circumscribing the data; and
a display control unit configured to, when a user having no authorization to browse the data designates display of the document data, display a page in which the circumscribed area generated by said circumscribed area generation unit is laid out at a position of the designated area.

2. The apparatus according to claim 1, further comprising:
a maximum area generation unit configured to generate a maximum area of the circumscribed area circumscribing data inserted into one area designated by the template; and
a maximum area display control unit configured to display a page in which the maximum area generated by said maximum area generation unit is laid out.

3. The apparatus according to claim 2, wherein the data stored in the database is inserted into the designated area, and a page is displayed by one of said display control unit and said maximum area display control unit in accordance with a user instruction.

4. The apparatus according to claim 1, further comprising a storage unit configured to read out data from the database and save the data in association with the designated area of each page.

5. An information processing method of outputting a preview image when inserting data stored in a database into an area designated by a template on a page that forms document data, and outputting the data, the method comprising:
a circumscribed area generation step of generating a circumscribed area circumscribing the data; and
a display control step of, when a user having no authorization to browse the data designates display of the document data, displaying a page in which the circumscribed area generated in the circumscribed area generation step is laid out at a position of the designated area.

6. The method according to claim 5, further comprising:
a maximum area generation step of generating a maximum area of the circumscribed area circumscribing data inserted into one area designated by the template; and
a maximum area display control step of displaying a page in which the maximum area generated in the maximum area generation step is laid out.

7. The method according to claim 6, wherein the data stored in the database is inserted into the designated area, and a page is displayed by one of the display control step and the maximum area display control step in accordance with a user instruction.

8. A computer-readable medium storing an information processing program of outputting a preview image when inserting data stored in a database into an area designated by a template on a page that forms document data, and outputting the data, the information processing program causing a computer
to generate a circumscribed area circumscribing the data, and
to, when a user having no authorization to browse the data designates display of the document data, display a page in which the generated circumscribed area is laid out at a position of the designated area.

9. The medium according to claim 8, wherein the information processing program further causes the computer
to generate a maximum area of the circumscribed area circumscribing data inserted into one area designated by the template, and
to display a page in which the generated maximum area is laid out.

10. The medium according to claim 9, wherein the data stored in the database is inserted into the designated area, and a page is displayed in accordance with a user instruction based on one of a page in which the generated circumscribed area is laid out and a page in which the generated maximum area is laid out.
